(19) United States
(12) Patent Application Publication
(10) Pub. No.: US 2012/0326991 A1
(43) Pub. Date: Dec. 27, 2012

(54) PORTABLE DATA TERMINAL HOUSING HAVING A ROTATABLE MEMBER FOR RETENTION OF A STYLUS

(75) Inventors: Sherri L. REED, Charlotte, NC (US); Eric H. LINN, JR., Fort Mill, SC (US)

(73) Assignee: HAND HELD PRODUCTS, INC., Skaneateles, NY (US)

(21) Appl. No.: 13/169,612

(22) Filed: Jun. 27, 2011

(51) Int. Cl. G06F 3/041; H01R 43/16

(52) U.S. Cl. 345/173; 29/874

(57) ABSTRACT

A portable data terminal includes a housing, a touch screen coupled to the housing, and a stylus for activating the touch screen. The housing includes a receptacle defining a passageway configured to receive at least a portion of the stylus therein. A rotatable member is operably rotatably disposed in the housing with a portion of the rotatable member protruding into the passageway of the receptacle. When the stylus is inserted and removed from the receptacle, the stylus engages the protruding portion of the rotatable member to rotate the rotatable member.

### FIELD OF THE INVENTION

This disclosure relates generally to portable data terminals, and more specifically, to portable data terminals having a touch screen stylus.

### BACKGROUND OF THE INVENTION

Portable data terminals (PDTs) are a type of data collection device used to collect, interpret, process, and ultimately transfer data to a larger data processing system. PDTs generally comprise a mobile computer, a keypad, and a data acquisition device. It is to be noted that some PDTs utilize more durable or “industrial” versions of their constituent components. The mobile computer generally comprises a hand held (or “pocket”) computing device, such as those available from Intel, Palm, Hewlett Packard, and Dell. Keypads come in a variety of alpha-numeric and numeric configurations. The data acquisition device generally comprises a device that captures data from, for example, radio frequency IDs (RFID), images, and bar codes. Data may also be captured via keypad entry and utilization of a touch pad associated with the mobile computer. PDTs are available from several sources, including the assignee of the present application: Honeywell Hand Held Products.

The user interface for PDTs typically include buttons and a touch screen display. The touch screen is used to both display information and to capture information. The data capture generally uses a stylus to select buttons or areas on the screen for certain functions, draw shapes onto the screen, use character recognition to enter text or numbers, or other methods of data capture.

Typically, the stylus is stored in the housing when not in use. For example, the stylus is often received in a receptacle disposed in the housing. One attempt at securing or holding the stylus in the housing includes sizing the receptacle in the housing and the stylus so that a tight contact between the two occurs when the stylus is inserted in the receptacle. In addition, an additional resilient element may be conventionally added in the cavity receptacle to press on the stylus. Another attempt has employed a latching mechanism that engages a groove disposed on the stylus.

U.S. Patent Application Publication No. 2003/0185619 by Nagaoka discloses an input pen capable of being held in any one of input pen holding parts respectively having different shapes of various personal digital assistants. The input pen has a barrel, and stopping members fitted in the opposite end parts of the metal tube. An elastic member is placed between the stopping members so as to push the stopping members outward. The metal tube is fitted in openings formed in the barrel. When the input pen is inserted in an input pen holding part of the personal digital assistant, the stopping members properly projecting outside through the openings of the barrel are pressed against the inner surface of the input pen holding part. Thus, the input pen will not move even if there is a space between the barrel and the inner surface of the input pen holding part. FIG. 26 of Nagaoka illustrates stopping members being spherical balls and a coil spring extending between the stopping members.

There is a need for further portable data terminals, and more specifically, to portable data terminals having a touch screen stylus.

### SUMMARY OF THE INVENTION

In a first aspect, the present invention provides a portable data terminal which includes a housing, a touch screen coupled to the housing, and a stylus for activating the touch screen. The housing includes a receptacle defining a passageway configured to receive at least a portion of the stylus therein. A rotatable member is operably rotatably disposed in the housing with a portion of the rotatable member protruding into the passageway of the receptacle. When the stylus is inserted and removed from the receptacle, the stylus engages the protruding portion of the rotatable member to rotate the rotatable member.

In a second aspect, the present invention provides a method for use in assembling a portable data terminal. The method includes providing a housing comprising a receptacle having a passageway configured to receive a stylus therein, and operably rotatably supporting a rotatable member in the housing so that a portion of the rotatable member protrudes into the passageway of the receptacle.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and the accompanying drawings in which:

FIGS. 1 and 2 are perspective views of one embodiment of a portable data terminal in accordance with an aspect of the present invention;

FIG. 3 is an enlarged, side elevational view of one embodiment of the stylus for the portable data terminal of FIG. 1;

FIG. 4 is a partial perspective view the upper end of the main body of the housing of FIG. 1 with the top cap removed illustrating the receptacle for the stylus and a roller ball disposed in an internal socket;

FIG. 5 is a partial perspective view the top cap of FIG. 1;

FIG. 6 is an enlarged top view of the upper end of the main housing of FIG. 4 illustrating the roller ball disposed in the internal cavity;

FIG. 7 is a cross-sectional view taken along line 7-7 in FIG. 6;

FIG. 8 is a perspective view similar to FIG. 4 with the top cap installed on the main body a the roller ball captured in the internal socket;

FIG. 9 is a perspective view of the upper end of the main body with the top cap remove and a stylus retained in the receptacle;

FIG. 10 illustrates a flowchart of one embodiment of a method for assembling a portable data terminal in accordance with an aspect of the present invention; and

FIG. 11 illustrates a flowchart of another embodiment of a method for assembling a portable data terminal in accordance with an aspect of the present invention.

### DETAILED DESCRIPTION OF THE INVENTION

Reference will now be made in detail to the present invention, examples of which are illustrated in the accompanying drawings, wherein like reference numerals refer to like elements throughout. The following description will use nomenclature associated with a PDT (portable data terminal), however those of ordinary skill in the art will recognize that the present invention is applicable to a variety of other devices with a touch screen interface, including personal data assistants (PDAs). Touch screen devices may include voltmeters, oscilloscopes, logic analyzers, and any other hand held, bench top, or rack mounted instruments. Hand held devices, such as cell phones, satellite phones, telemetric devices, and other hand held devices are also to be classified as PDTs for the purposes of this specification. The term PDT shall also include any computer terminal display that has a touch screen interface. These may comprise kiosks, outdoor terminal interfaces, industrial computer interfaces, commercial computer interfaces, and other computer displays. Additionally, the term PDT may comprise barcode scanners and consumer electronics.

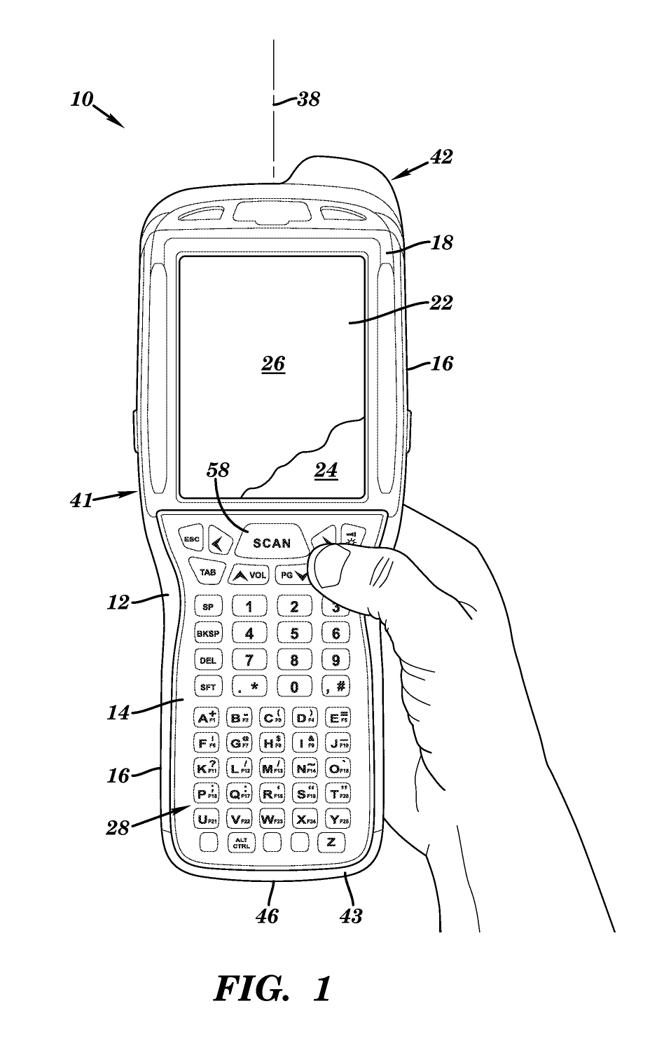

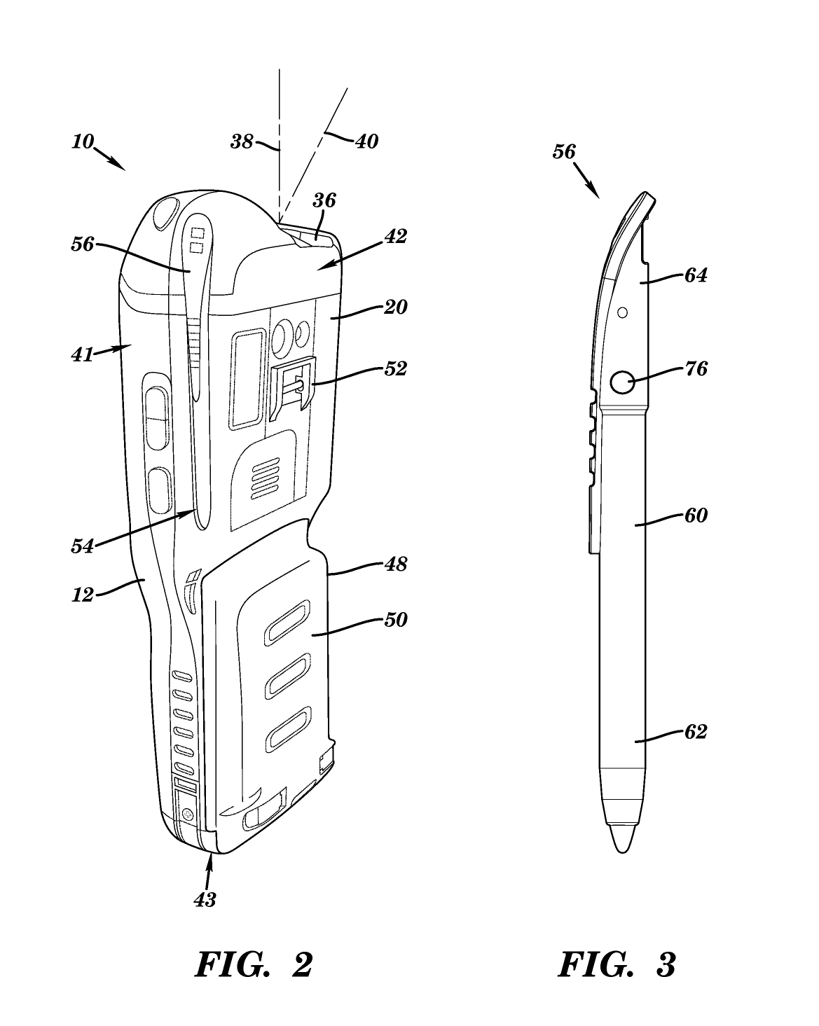

FIG. 1 illustrates one embodiment of a portable data terminal (PDT) 10 in accordance with one aspect of the present invention. In this exemplary embodiment, PDT 10 may include a housing 12 having an upper surface 14, side surface 16, front surface 18, and rear surface 20 (shown in FIG. 2). For example, housing 12 may be generally assembled from a main body 41 such as a tube structure or shell, a top cap 42, and a bottom cap 43. The PDT 10 utilizes a popular form factor, but in some embodiments may further include a handle (not shown).

The housing 12 generally supports a variety of components, including a battery (not shown but typically located the rear half of the body) and a touch panel or touch screen 22 comprising a display 24 and a touch sensitive overlay 26 disposed over the display. In this manner, the touch screen 22 operates as a data input interface. The housing 12 may further include a keyboard 28 enabling input of data. PDT 10 may also include a graphical user interface, or “GUI”, integrated with the display 24. GUI may include a pointer that is moved by an operator to select between various displayed (sometimes referred to as “virtual”) control buttons displayed on the display. The pointer may be moved during web browsing to select a text or icon hyperlink control button for highlighting. Control buttons may also be displayed for selecting between various menu options. In one example, the control buttons may be a series of icons. Selecting one of the icons changes the mode of operation of the PDT 10 in accordance with the selected icon. In some embodiments, the PDT 10 may include a pointer controller enabling movement of the pointer. The pointer controller may be provided by an arrow navigation matrix, a trackball or a joystick. In further embodiments, the GUI includes a “virtual” keyboard, thereby obviating the need for additional hardware.

The portable data terminal 10 may further include a scan engine 36 integrated into top cap 42 of the PDT. The scan engine 36 may comprise, for example, an image engine or a laser engine aligned along a longitudinal axis 38. An imaging axis 40 (shown in FIG. 2) of the portable data terminal 10 extends in the general direction of the longitudinal axis 38, but may extend in a direction slightly angularly downward with respect to longitudinal axis. Top cap 42 may encapsulate the image engine and control circuits (not shown).

The PDT 10 may further include a data/charging port 46 disposed along the bottom of the portable data terminal. The data/charging port 46 typically comprises a proprietary interface with one set of pins or pads for the transmitting and receiving of data and a second set of pins or pads for receiving power for powering the system and/or charging the battery.

The touch screen 22 comprises either a color or black and white liquid crystal display 24 with a touch sensitive overlay 26 mounted on top of the display. The display 24 is used for displaying graphics, text, and other elements to the user. The touch screen 22 is preferably used with a stylus to select elements from the screen, draw figures, or enter text with a character recognition program, for example.

In use, the user may actuate a trigger button 58 to initiate an image capture via the scan engine 36. The captured image is analyzed, e.g., decoded, to identify the data it represents. The decoded data is stored and possibly displayed on the PDT 10. Additional processing of the data may take place on the PDT 10 and/or a data processing resource to which the data is transmitted via any available transport mechanism on the PDT. Some examples of known transport mechanisms utilized by PDTs include: Bluetooth, WiFi, GSM, CDMA, USB, IrDA, removable FLASH memory, parallel and serial ports (including for example, RS-232).

With reference to FIG. 2, the housing 12 of the portable data terminal 10 includes a lower side 48 which may include a battery compartment 50 and a strap clip 52. The housing 12 may further include a receptacle 54 for receiving and retaining a stylus 56 for activation of the touch screen 22 (FIG. 1). The receptacle 54 may be located in any convenient location. In the illustrated embodiment, the receptacle 54 is located on the rear surface 20 of the PDT housing 12, but may also be located on the side surface 16 or in a handle, if present.

As shown in FIG. 3, stylus 56 may generally resemble a conventional writing implement. In one embodiment, stylus 56 may include an elongated cylindrical body 60 having a proximal end 62 and an opposing distal end 64. The proximal end 62 may taper to a frustoconical tip having solid rounded end. The tip is used to make contact with the touch sensitive overlay. The stylus may be one-piece and manufactured from any suitable material, for example by plastic injection molding.

With reference again to FIGS. 1 and 2, the top cap 42 may be stronger than the main body 41, by comprising a stronger material, by comprising thicker walls, and/or by comprising reinforcing structures, such as reinforcement ridges, to add structural strength. The additional strength of the top cap 42 may protect the hand held computer terminal from physical shock, the type of which can occur when the hand held computer terminal is dropped. When the PDT is dropped, the top or the bottom of the device is most likely to be directly impacted.

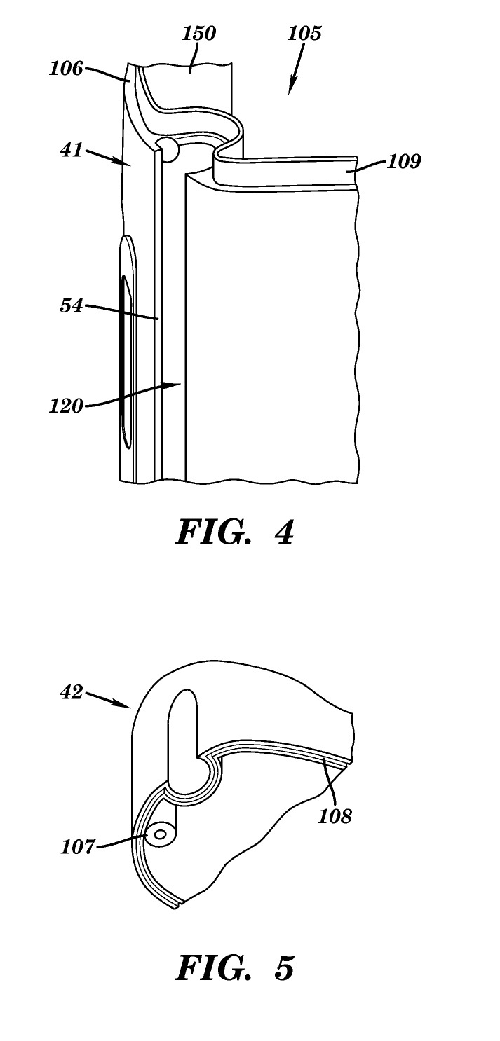

As shown in FIG. 4, main body 41 of the housing includes receptacle 54 defining a passageway 120 therein configured to receive a portion of the stylus therein. Receptacle 54 may define an opening or a slot extending along at least a portion of the passageway so that at least a portion of the stylus is exposed when the stylus is disposed in the receptacle. Main body 41 may further define a top opening 105. An upper edge of main body 41 may include a landing or stop 106 and a raised ridge 109 which extends around opening 105.

With reference to FIG. 5, top cap 42 may include a top releasable fastener mount having holes 107 (only one mount being shown in FIG. 5) and a groove 108 extending around the inside surface of the top cap 400.

The top cap 42 may be assembled onto main body 41 to cover the top opening 105. For example, the raised ridge 109 of the main body 41 may fit into the groove 108 of the top cap 42. A relatively small or minimal clearance can be provided between the raised ridge 109 and groove 108 of the top cap 42 to facilitate better sealing and a more secure fit. The outer surfaces of the main housing 41 and the outer surfaces of the top cap 42, at the joint between the main body 41 and the top cap 42, may substantially align to form a smooth seam along the outside of the housing. A gasket may be provided and positioned between top cap 42 and main body 41 to seal the joint. The top gasket may be a conventional gasket, such as a gasket made of rubber or plastic, or a gasket foamed into place. The top cap 42 can be tightened to the main body 41, for example, with screws through the top fastening holes 107 of the top cap 42 into fastening holes of the main body or an internal frame member (not shown).

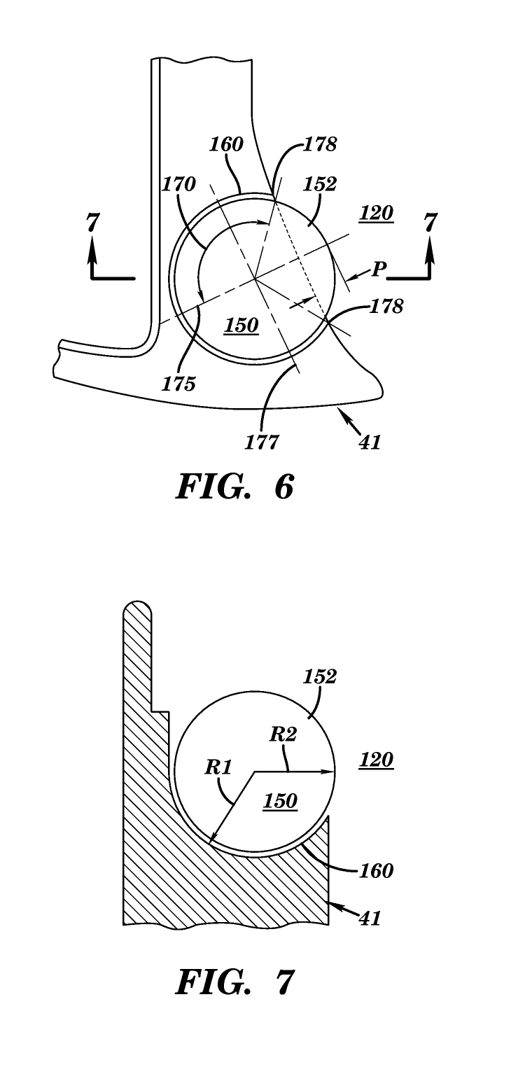

With reference to FIGS. 4 and 6-8, a rotatable member such as, for example, a roller ball 150 may be contained in the housing for releasably retaining the stylus in the housing in accordance with an aspect of the present invention. For example, the main body 41 and the top cap 42 (FIG. 5) may together cooperate to define an internal socket for containing the roller ball 150 captured therein with a portion 152 of roller ball 150 protruding into passageway 120 of the receptacle. When the stylus is received in the receptacle, a portion of the stylus engages a portion of the roller ball such as a circumferentially extending portion, and repeated insertion and removal of the stylus from the receptacle may result in wear being borne by the stylus compared to being borne by the housing and/or the roller ball.

The upper end of main housing may define an internal socket 160 having a spherical portion having a radius R1. The internal socket 160 is configured to capture roller ball 150. The roller ball 150 has a second, smaller spherical radius R2 to permit the ball to freely rotate within the socket 160. The second spherical radius R2 of the roller ball 150 is less than the first spherical radius by a distance ranging from 0.025 millimeters to 0.250 millimeters (0.001 inches to 0.010 inches). The roller ball may have a diameter between about 2.5 millimeters and about 2.7 millimeters, although it is appreciated that other sizes would be suitable.

The lower portion of the socket 160 is configured to retain the roller ball 150 from falling downwardly out of the main body 41 of the housing, and to prevent the ball from completely withdrawing into the main body 41 when force is exerted on the roller ball when inserting and rotating the stylus. The spherical radius R1 in the socket 160 further defines a lower capturing and retention region 170 on the lower half of the socket to accomplish this purpose. The region 170 defines an arc between an axis 175 disposed generally though the center of the roller ball which is normal to an axis extending through edges 178 of socket 160 which edges 178 are formed between the intersection of the internal socket 160 and passageway 120. Region 170, when rotated downwardly about axis 175, forms a cup region in front of a vertical plane 177 to secure the roller ball 150 from falling out of the main body 41. The region 170, when rotated downwardly about axis 175, also forms a cup behind vertical plane 177 that prevents the roller ball 70 from pushing horizontally into main body 41. In the illustrated example, the region 170 is an arc of approximately 135 degrees (45 degrees from axis 177, and 90 degrees from axis 177). The socket 160 may further be configured to assure that the roller ball 150 protrudes a predetermined distance from the edge of the internal socket into the passageway which receives the stylus. The roller ball 150 may protrude into the passageway by a distance P, and wherein P is less than one half of the spherical radius of the roller ball, less than one quarter of the spherical radius of the roller ball, a distance therebetween, or any suitable distance while maintaining that roller ball remains captured in the socket.

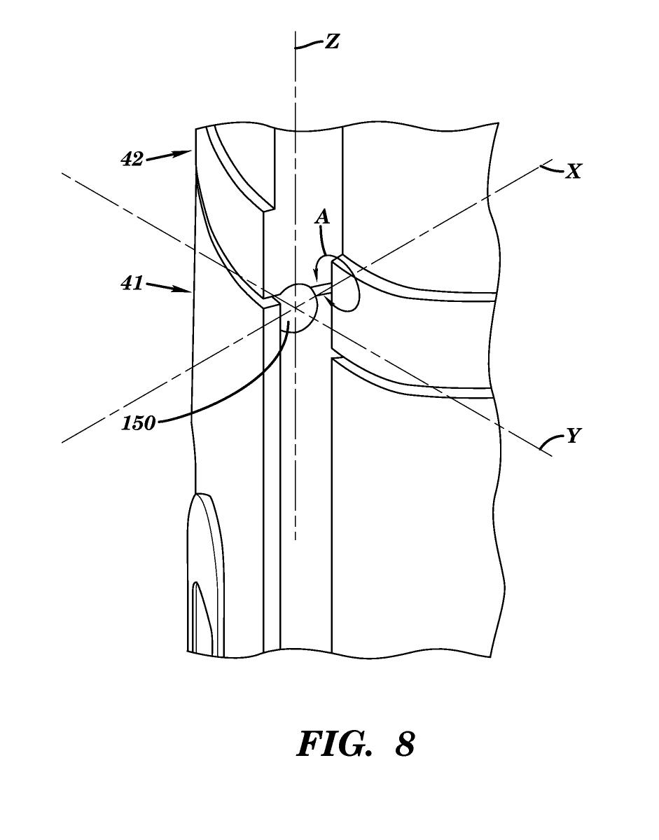

With reference to FIG. 8, it will be appreciated that roller ball 150 is rotatable supported about generally fixed X, Y, and Z axes or orientation relative to said housing. The roller ball may rotate in a direction of double-headed arrow A, such as in 360 degrees around axis X when the stylus is inserted or removed from the receptacle, and the roller ball may be rotatable about symmetrical portions of the roller ball.

From the present description, it will be appreciated by those skilled on the art that the internal socket may be primarily defined in the main body, and the top cap provides a generally flat surface for covering the roller ball and the internal socket in the main body to capture and cause the roller ball to be contained in the internal socket. Alternatively, the main body and the top cap may be configured where the main body comprises a lower half of the internal socket and the top cap comprises an upper half of the internal socket. In such a configuration, both the main body and the top cap may include a spherical surface for receiving the roller ball therein. Further, the top cap may primarily define the internal socket and the main body comprise a flat surface for covering the internal socket in the top cap to capture and cause the roller ball to be contained in the internal socket. It will be appreciated that other possible configuration of the mating portions of the main body and the top cap may be suitably employed to define the internal socket, which when the main body and the top cap are assembled, the roller ball is retained.

The roller ball, the housing, and the stylus may be formed and configured so that when the stylus is inserted and removed from the receptacle, the stylus engages the roller ball without sliding relative to each other, and the roller ball rotates in the internal socket.

The roller ball 150 may be manufactured from or coated with a material so that the static and dynamic frictional forces observed between the roller ball and the internal socket are less than the static and dynamic frictional forces, respectively, observed between the roller ball and the stylus when the stylus is inserted and removed from the receptacle. For example, the roller ball may be manufactured from a material that provides a sufficiently high coefficient of friction relative to the stylus that the frictional forces will cause the roller ball to roll within the internal socket when contacting the stylus, rather than simply skidding along the surface of the stylus. Desirably, this results in the roller ball rotating within the socket when the stylus is inserted or removed from the receptacle. The dynamic coefficient of friction (p) is defined as friction force F divided by the applied load N (p=F/N) at a given sliding speed.

Additionally, the material for the roller ball 150 should exhibit high resistance to wear, which is the progressive loss of material due to interacting surfaces in relative motion. The roller ball may comprise a first material having a first resistance to wear, and the stylus may comprise a second material having a second resistance to wear which is less than the first resistance to wear.

One choice of material is a metal such as stainless steel. The main body of the housing may be formed from a thermoplastic polymer material such as a polycarbonate plastic material, ABS (acrylonitrile butadiene styrene), or a DuPont DELRIN acetal resin material. The stylus may be formed form a polycarbonate plastic material, DuPont DELRIN acetal resin material, or a metal. The roller ball may be formed from a from a thermoplastic polymer material.

With reference again to FIG. 3, the distal end 64 of the body 60 of stylus 56 may include a capture element 76 for securing the stylus into the receptacle 54 in the housing 12 (FIG. 1). In this illustrated embodiment, the capture element 76 is an indentation, cavity, or notch. The indentation or cavity engage with the corresponding protrusion of the roller ball within the stylus receptacle 54, typically in slight interference-fit fashion, to secure the stylus 56 when not in use. It will be appreciated that in another embodiment of the stylus, the capture element may be a groove spanning a perimeter of the stylus body. The groove may engage the corresponding protrusion of the roller ball within the stylus receptacle, typically in slight interference-fit fashion, to secure the stylus when not in use.

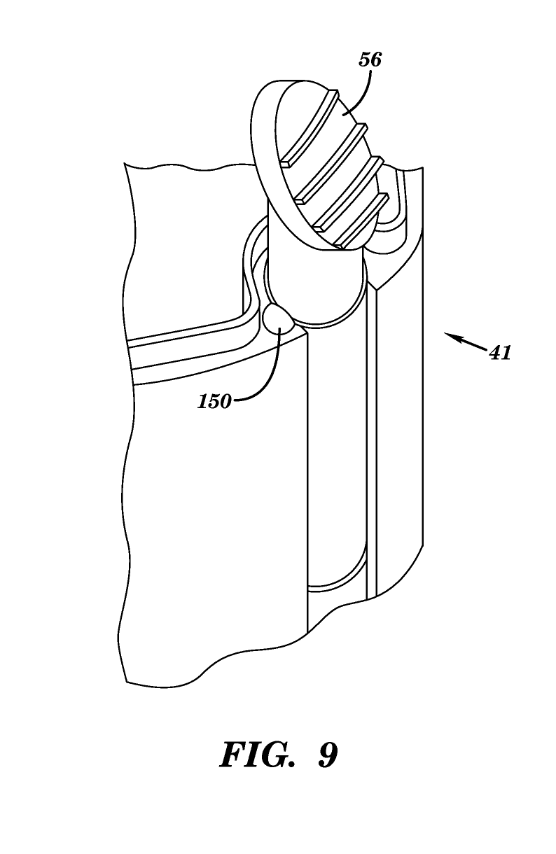

FIG. 8 illustrates the roller ball 150 captured between the main housing 41 and the top cap 42. FIG. 9 illustrates stylus 56 disposed in the main body 41 without the top cap.

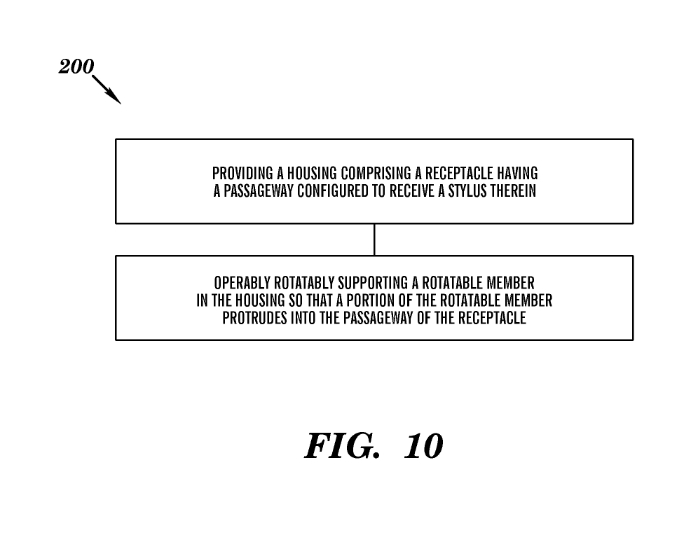

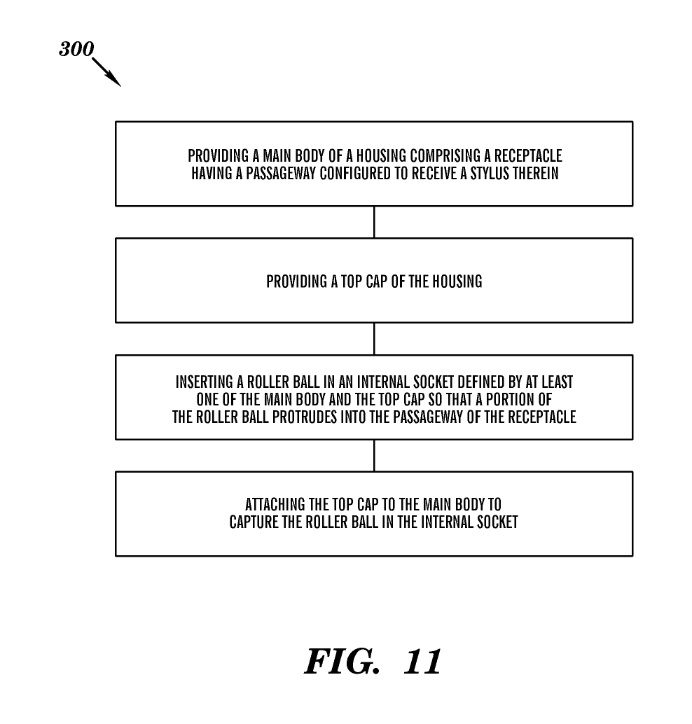

FIG. 10 illustrates a flowchart of a one embodiment of a method 200 for assembling a portable data terminal in accordance with an aspect of the present invention. FIG. 11 illustrates a flowchart of another embodiment of a method 300 for assembling a portable data terminal in accordance with an aspect of the present invention.

From the present description, it will be appreciated that other configuration the rotatable members and other means for rotatably supporting the rotatable member may be suitably employed.

In addition, one embodiment of the stylus may include a stylus having a tip comprising a roller ball such as the stylus described and illustrated in U.S. patent application Ser. No. 12/996,543, entitled “Portable Data Terminal Stylus With Rolling Ball Tip” by Linn, the entire subject matter of the application being incorporated herein by reference.

One advantage of an aspect of the present invention described herein is that the roller ball extends the life of the housing. In particular, the present invention overcomes the problem of where the stylus retention is on the housing, and repeated insertion/removal of the stylus results in increased wear and stress on the housing causing the need for replacement of the housing. For example, the housing is typically expensive and is service replaceable only, while the stylus is inexpensive and is end-user replaceable.

Another advantage of an aspect of the present invention is that the roller ball may rotate freely within the socket, hereby reducing the wear on the stylus compared to, for example, the stylus sliding against a raised detent extending from the housing into the passageway of the receptacle.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been described, it will be understood that features and aspects that have been described with reference to each particular embodiment can be used with each remaining particularly described embodiment.

1. A portable data terminal comprising:
a housing;
a touch screen operably coupled to said housing;
a stylus for activating said touch screen;
said housing comprising a receptacle defining a passageway configured to receive at least a portion of said stylus therein;
a rotatable member operably rotatably disposed in said housing with a portion of said rotatable member protruding into said passageway of said receptacle; and
wherein when said stylus is inserted and removed from said receptacle, said stylus engages said protruding portion of said rotatable member to rotate said rotatable member.

2. The portable data terminal of claim 1 wherein said rotatable member is rotatable supported about generally fixed X, Y, and Z axes relative to said housing.

3. The portable data terminal of claim 2 wherein said rotatable member rotates around one of the axes when said stylus is at least one of inserted and removed from said receptacle.

4. The portable data terminal of claim 1 wherein said rotatable member comprises an axis of rotation.

5. The portable data terminal of claim 1 wherein said protruding portion of said rotatable member comprises a circumferentially extending portion.

6. The portable data terminal of claim 1 wherein said stylus comprises a cavity for receiving a portion of said protruding portion of said rotatable member when said stylus is disposed in said receptacle of said housing.

7. The portable data terminal of claim 1 wherein said housing comprising an internal socket, and said rotatable member comprises a roller ball captured in said internal socket with a portion of said roller ball protruding into said passageway of said receptacle, and when said stylus is inserted and removed from said receptacle, said stylus engages said protruding portion of said roller ball to rotate said roller ball within said internal socket.

8. The portable data terminal of claim 7 wherein said roller ball is rotatable supported about generally fixed X, Y, and Z axes relative to said housing.

9. The portable data terminal of claim 7 wherein said housing comprising a main body and a top cap which are operably connectable to define said internal socket for containing said roller ball therein.

10. The portable data terminal of claim 7 wherein said internal socket comprises a first spherical radius, and said roller ball comprises a second spherical radius that is less than said first spherical radius.

11. The portable data terminal of claim 7 wherein said roller ball protrudes into said passageway by a distance P, and wherein P is less than one half of said second spherical radius.

12. The portable data terminal of claim 7 wherein said stylus comprises a cavity for receiving a portion of said protruding portion of said roller ball when said stylus is disposed in said receptacle of said housing.

13. The portable data terminal of claim 1 wherein said rotatable member comprises a first material having a first resistance to wear, and said stylus comprises a second material having a second resistance to wear which is less than said first resistance to wear.

14. The portable data terminal of claim 1 further comprising at least one of a processor coupled to said touch screen, memory operably coupled to said processor, and a keyboard operably coupled to the housing and to said processor.

15. A method for use in assembling a portable data terminal, the method comprising:
providing a housing comprising a receptacle having a passageway configured to receive a stylus therein; and
operably rotatably supporting a rotatable member in the housing so that a portion of the rotatable member protrudes into the passageway of the receptacle.

16. The method of claim 15 wherein the operably rotatably supporting comprises operably rotatably supporting the rotatable member about generally fixed X, Y, and Z axes relative to the housing.

17. The method of claim 15 wherein said rotatable member comprises an axis of rotation

18. The method of claim 15 wherein said protruding portion of said rotatable member comprises a circumferentially extending portion.

19. The method of claim 15 further comprising providing a stylus having cavity, and inserting the stylus in the receptacle so that the stylus engages the protruding portion of the rotatable member to rotate the rotatable member without sliding, and so that the cavity of the stylus receives the portion of the protruding rotatable member.

20. A method for of claim 15 wherein said rotatable member comprise a roller ball, and wherein:
the providing the housing comprises providing a main body comprising the receptacle and a top cap; and
the operably rotatably supporting the rotatable member comprises inserting a roller ball in an internal socket defined by at least one of the main body and the top cap so that a portion of the roller ball protrudes into the passageway of the receptacle, and operably attaching the top cap to the main body to capture the roller ball in the internal socket.

21. The method of claim 20 further comprising providing a stylus having cavity, and inserting the stylus in the receptacle of the assembled main body and top cap so that the stylus engages the protruding portion of the roller ball to rotate the roller ball, and so that the cavity of the stylus receives the portion of the protruding rotatable ball.

22. The method of claim 20 wherein the internal socket comprises a first spherical radius, and the roller ball comprising a second spherical radius that is less than the first spherical radius.

23. The method of claim 22 wherein the roller ball protrudes into the passageway by a distance P, and wherein P is less than one half of the second spherical radius.

24. The method of claim 20 wherein the roller ball comprises a first material having a first resistance to wear, and the stylus comprises a second material having a second resistance to wear which is less than the first resistance to wear.

25. The method of claim 20 further comprising operable attaching at least one of a processor, memory, and a keyboard to the touch screen and to the housing.
